(19) United States
(12) Patent Application Publication
(10) Pub. No.: US 2009/0137713 A1
(43) Pub. Date: May 28, 2009

(54) Ink for Marking

(76) Inventors: Mariko Muto, Kiyosu-shi (JP); Minoru Yamada, Kiyosu-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/223,066

(22) PCT Filed: Jan. 12, 2007
(86) PCT No.: PCT/JP2007/050319

§ 371 Date: Sep. 8, 2008

(30) Foreign Application Priority Data
Mar. 31, 2006 (JP) 2006-021822

(51) Int. Cl. C08K 5/07

(52) U.S. Cl. 524/356

(57) ABSTRACT

In each of an organic solvent, an oil-soluble dye and an oil-soluble resin to be contained in an ink for marking, and a resin adopted in an article to be marked with the ink for marking, it is necessary that absolute values of differences between mutual solubility parameters are not more than constant values, respectively.

### BACKGROUND OF THE INVENTION

1. Field of the Invention

The present invention relates to an ink for marking which marks an outer surface of an article such as a covered electric wire, a connector for the covered electric wire or the like.

2. Description of the Prior Art

In this kind of the ink for marking, there has been, conventionally, disclosed an ink for marking an outer surface of a covered electric wire for discriminating the covered electric wire constituting a wire harness in an automatically marking method of articles described in Japanese Patent Early Publication No. 2004-134371.

As this ink, there are exemplified an acryl-based paint, a dye-based ink, a pigment-based ink or a UV ink.

Meanwhile, the ink for marking is required to have the following performances, on actually manufacturing a wire harness industrially.

First, stability of the ink is required. The stability of the ink is required at a stage until the covered electric wire consisting a wire harness is marked. For instance, the stability of the ink is required when the ink for marking is manufactured, transported or stored, and when the ink for marking is coated on an outer surface of an article.

Secondly, ensuring well distinguishability after marking is required. For ensuring well the distinguishability, required are forming property of a film from resin components in the ink for marking, adhesiveness between the film and an outer surface of an article, or various fastnesses after marking.

In the ink described in the above-mentioned Japanese Early Patent Publication, however, nothing is described regarding the aforementioned performances. As the result, it leads to a drawback that the ink may not satisfy the aforementioned performances.

It is, therefore, an object of the present invention to provide an ink for marking which is used for marking an outer surface of an article having at least the outer surface formed of a resin, and which is excellent in stability thereof and distinguishability after marking.

### SUMMARY OF THE INVENTION

To solve the aforementioned drawback, the present inventors have studied intensively and, as a result, have found out that the above-mentioned object may be attained on the basis of a ground that an organic solvent, an oil-soluble dye and an oil-soluble resin contained in an ink for marking have in a nature thereof a mutual constant relationship with a resin (hereinafter, referred to as “a resin for an article”) forming an outer surface of the article which is marked with the ink for marking.

That is, the ink for marking in accordance with the present invention is an ink for marking which marks an outer surface of an article having at least the outer surface formed of a resin, wherein the ink for marking comprises an organic solvent, an oil-soluble dye and an oil-soluble resin, and wherein the following respective equations are satisfied:

|δ1−δ2|≦3.0 (J/cm³)^{1/2} (1)

|δ1−δ3|≦3.0 (J/cm³)^{1/2} (2)

|δ2−δ3|≦3.0 (J/cm³)^{1/2} (3)

|δ3−δ4|≦5.0 (J/cm³)^{1/2} (4),

when a solubility parameter of the organic solvent is denoted by δ1, a solubility parameter of the oil-soluble dye is denoted by δ2, a solubility parameter of the oil-soluble resin is denoted by δ3 and a solubility parameter of the resin for an article is denoted by δ4.

Herein, the equation (1) requires that an absolute value of a difference between solubility parameters is within a range of not more than 3.0 (J/cm³)^{1/2} in a relationship between the organic solvent and the oil-soluble dye. Thereby, the oil-soluble dye becomes in the state where it is well dissolved in the organic solvent.

And, the equation (2) requires that an absolute value of a difference between solubility parameters is within a range of not more than 3.0 (J/cm³)^{1/2} in a relationship between the organic solvent and the oil-soluble resin. Thereby, the oil-soluble resin becomes in the state where it is well dissolved in the organic solvent.

Therefore, by satisfying the aforementioned equation (1) and equation (2), may be well ensured, for instance, a stability of an ink for marking which is necessitated when the ink for marking is manufactured, transported or stored, and when the ink for marking is coated on an outer surface of an article.

Next, the equation (3) requires that an absolute value of a difference between solubility parameters is within a range of not more than 3.0 (J/cm³)^{1/2} in a relationship between the oil-soluble dye and the oil-soluble resin. Thereby, after formation of a film from the oil-soluble resin, the film formed from the oil-soluble resin is brought into the stably colored condition by means of the oil soluble dye.

Furthermore, the equation (4) requires that an absolute value of a difference between solubility parameters is within a range of not more than 5.0 (J/cm³)^{1/2} in a relationship between the oil-soluble resin and the resin for an article. Thereby, the strong affinity state is maintained mutually between the oil-soluble resin and the resin for an article.

Therefore, by satisfying the aforementioned equation (3) and equation (4), may be improved film forming property of the oil-soluble resin, adhesiveness between the film and an outer surface of an article, or various fastnesses after marking, to thereby well ensure distinguishability after marking.

Thus, by satisfying all of the aforementioned equation (1), equation (2), equation (3) and equation (4), it is capable of providing an ink for marking which is used for marking an outer surface of an article, at least the outer surface of the article being formed of a resin, and which is excellent in stability and distinguishability after marking.

Herein, with this invention, the article refers to an entity of which at least an outer surface is formed of a resin. Specifically, as the article, exemplified is a covered electric wire, a wire harness (which is a bundle of a plurality of covered electric wires), or an associated article of a wire harness such as a connector, a tube, a tape, a cover, a clip or the like.

Further, with this invention, the resin for an article is a material which is a subject to be marked by the ink for marking. The resin for an article is not particularly limited, but is generally an organic polymeric compound, and includes a thermoplastic resin, a thermosetting resin and the like.

With this invention, the ink for marking is used for marking an outer surface of an article, and contains at least an organic solvent, an oil-soluble dye and an oil-soluble resin.

The ink for marking contains in some cases a component such as a solubilizer for the oil-soluble dye, a crosslinking agent or a plasticizer for the oil-soluble resin.

The ink for marking in accordance with the present invention is used when it is coated on an outer surface of an article by a general method. Herein, the general method refers, for example, to discharge the ink for marking as an aerosol together with a pressurized gas, or to discharge the ink for marking with the liquid droplet condition. An example of this discharge is, concretely, discharge with an ultrafine amount discharging device such as discharge by an ink jet system, discharge with a microdispenser, or discharge with a so-called microvalve.

### DESCRIPTION OF THE PREFERRED EMBODIMENT

Hereinafter, an embodiment of an ink for marking in accordance with the present invention will be explained.

The ink for marking referred in this embodiment is an ink which is used when a covering member of a covered electric wire adopted as a member constituting a wire harness is marked at an outer surface thereof by an ink jet system.

The covered electric wire is constructed by means of covering a naked electric wire with a covering member. The covering member is manufactured by molding an electrically insulating resin (corresponding to a resin for an article) with the thermal plasticity by an extrusion method or the like. Examples of the electrically insulating resin include polyamide resin, polyester resin, polyvinyl chloride resin, polyolefin resin and the like. Particularly, the polyvinyl chloride resin has been conventionally used widely in an electrically insulating resin adopted as a covering member for a covered electric wire.

In recent years, polyolefin resin has been adopted in place of the conventional polyvinyl chloride resin, based on request of non-halogen in a covered electric wire adopted in a wire harness for an automobile. Particularly, marking is difficult in a covering member adopting the polyolefin resin, and the marking is not satisfied with the conventional ink for marking.

Herein, examples of the polyolefin resin include resins such as polyethylenes like low density polyethylene, medium density polyethylene, high density polyethylene or the like, and polypropylenes like homopolypropylene, block polypropylene, random polypropylene or the like.

In this embodiment, a discharge type of ink jet may be any of a drop-on-demand type and a continuous-flow-type. In case the continuous-flow-type is adopted, it is necessary to add to an ink a component imparting suitable electric conductivity. In this case, the component must be added in such a range that the present invention may not be influenced.

As the ink jet system, may be adopted, for example, any system such as a thermal ink jet system, a bubble jet system, a piezo system, an electrostatic actuator system or the like.

In this embodiment, drying of an ink for marking after discharged by an ink jet system may not be particularly limited. The drying may be done at an arbitrary temperature, for instance natural drying at a room temperature, or forced drying with a warm wind of a predetermined temperature, conduction, radiation or the like.

Further, in this embodiment, the ink for marking is an ink manufactured by dissolving oil-soluble dye and oil-soluble resin into organic solvent.

Herein, examples of the organic solvent are not limited to, but include alcohol-based solvents such as methyl alcohol, ethyl alcohol, isopropyl alcohol, butyl alcohol, benzyl alcohol and the like; polyhydric alcohol-based solvents such as ethylene glycol, glycerin and the like; ether-based solvents such as ethylene glycol monomethyl ether, ethylene glycol monoethyl ether, dioxane, tetrahydrofuran and the like; ester-based solvents such as ethyl acetate and the like; ketone-based solvents such as acetone, methyl ethyl ketone, methyl isobutyl ketone, cyclohexanone and the like; hydrocarbon-based solvents such as n-hexane, cyclohexane, benzene, toluene, mineral spirit and the like; and nitrile-based solvents such as acetonitrile and the like. In this embodiment, acetone or methyl ethyl ketone is particularly preferable among the aforementioned organic solvents.

Regarding these organic solvents, it is possible to adopt reference values as their solubility parameters.

Additionally, the organic solvent contained in the ink for marking may be used by mixing two or more kinds of organic solvents in a relationship to the oil-soluble dye and the oil-soluble resin therewith.

Particularly, in case the organic solvent contained in the ink for marking is used by mixing acetone or methyl ethyl ketone and other organic solvent therewith, it is preferable that the organic solvent after mixed, as previously described contains acetone or methyl ethyl ketone at 80% or more of a volume fraction thereof.

Next, examples of the oil-soluble dye are not limited to, but include C.I. Solvent Yellow 2, 13, 14, 16, 21, 25, 33, 56, 60, 88, 89, 93, 104, 105, 112, 113, 114, 157, 160, 163, C.I. Solvent Red 3, 18, 22, 23, 24, 27, 49, 52, 60, 111, 122, 125, 127, 130, 132, 135, 149, 150, 168, 179, 207, 214, 225, 233, C. I. Solvent Blue 7, 14, 25, 35, 36, 59, 63, 67, 68, 70, 78, 87, 94, 95, 132, 136, 197, C. I. Solvent Black 3, 7, 28, 29, C. I. Solvent Violet 8, 13, 31, 33, 36, C. I. Solvent Orange 11, 55, 60, 63, 80, 99, 114, C. I. Solvent Brown 42, 43, 44, C. I. Solvent Green 3, 5, 20.

Besides, the oil-soluble dye may include disperse dye, pigment, vat dye, basic dye or the like which is possible to be adopted to the object of the present invention. The oil-soluble dye includes, for instance, C. I. Disperse Yellow 54, 82, 160, C.I. Disperse Red 22, 60, C.I. Disperse Blue 14, 197, C.I. Disperse Violet 13, 28, 31, 33, 57, C.I. Pigment Yellow 147, C.I. Pigment Red 181, C.I. Vat Red 41, C.I. Basic Blue 7 or the like. Further, it is capable of using a commercially available oil-soluble dye without a C.I. Number as the oil-soluble dye.

By measuring solubility parameters of these oil-soluble dyes, oil-soluble dye which may attain the object of the present invention may be easily selected in order to suit for an oil-soluble resin of the subject. Oil-soluble dye contained in the ink for marking may be used under appropriate blend in consideration with a hue of desired marking. In addition, an amount of the oil-soluble dye contained in the ink for marking to be used may be appropriately determined by color depth of marking.

Next, examples of the oil-soluble resin are not limited to, but include resin such as acryl resin, polyamide resin, polyester resin, unsaturated polyester resin, epoxy resin, phenol resin, urethane resin, polyvinyl chloride resin, polyvinyl acetate resin, polyethylene resin, polyimide resin, polycarbonate resin, ethylene vinyl acetate copolymer resin, ethylene vinyl chloride copolymer resin, polyimide resin, urea resin, ABS resin, AS resin, NBR, SBR, polyvinyl alcohol, polyvinyl ether or the like. Among them, the acryl resin is particularly preferable in this embodiment.

As the above-mentioned acryl resin, used is homopolymer of acrylic acid, acrylic acid ester (methyl ester, ethyl ester, hydroxyethyl ester, propyl ester etc.) or methacrylic acid ester (methyl ester, ethyl ester, hydroxyl ethyl ester, propyl ester etc.), or copolymer of two or more of them, or copolymer of them with other monomer. A molecular weight of each of these resins is selected appropriately on the basis of a viscosity of an ink and fastness of a film.

In this case, it is preferable that the ink for marking in accordance with the present invention has a viscosity within a range of 0.3 to 3.5 (mPa·s). Stability of the ink for marking which is discharged through an ink jet nozzle becomes better, in case the viscosity of the ink for marking is within the aforementioned range.

Herein, the viscosity of the ink for marking may be measured by a variety of methods. In the present invention, the viscosity has been measured by an oscillation method. For this measurement, a viscometer of SV-10 type manufactured by A & D Co. Ltd is exemplified as a viscosity measuring device.

By measuring a solubility parameter of the above-mentioned oil-soluble resin, an oil-soluble dye which may attain the object of the present invention may be easily selected in order to suit for an electrically insulating resin (corresponding to a resin for an article) of the subject.

And, an amount of the oil-soluble resin to be used in the ink for marking may be appropriately determined depending on fastness which is required based on a hue and a color depth of the ink for marking. Alternatively, a plurality of resins may be used by appropriately blending them.

As described above, for marking an outer surface of the covering member of the covered electric wire by using an ink jet system, in this embodiment, it is necessary first to ensure well stability of an ink and secondly to ensure well distinguishability after marking.

That is, the ink for marking in accordance with the present invention is characterized in that the following equations are satisfied:

|δ1−δ2|≦3.0 (J/cm³)^{1/2} (5)

|δ1−δ3|≦3.0 (J/cm³)^{1/2} (6)

|δ2−δ3|≦3.0 (J/cm³)^{1/2} (7)

|δ3−δ4|≦5.0 (J/cm³)^{1/2} (8),

when a solubility parameter of the organic solvent is denoted by δ1, a solubility parameter of the oil-soluble dye is denoted by δ2, a solubility parameter of the oil-soluble resin is denoted by δ3 and a solubility parameter of the resin for an article is denoted by δ4.

Herein, the solubility parameter is a value used when solubility of a nonelectrolyte against an organic solvent is assessed. The solubility parameter was, initially, proposed by Hildebrand and Scott and, thereafter, was developed by Hansen, and is widely used today. That is, it can be understood that substances having near values of the solubility parameters are compatible well, or have affinity.

The aforementioned each equation will be explained. First, in the equation (5), it is necessary that an absolute value of a difference between a value of the solubility parameter (δ1) of the organic solvent and a value of the solubility parameter (δ2) of the oil-soluble dye is within a range of not more than 3.0 (J/cm³)^{1/2}, and is preferably within a range of not more than 2.0 (J/cm³)^{1/2}.

Thereby, affinity between the organic solvent and the oil-soluble dye becomes strong, and the oil-soluble dye is brought into a state where it is well dissolved in an organic solvent.

Secondly, in the equation (6), it is necessary that an absolute value of a difference between a value of the solubility parameter (δ1) of the organic solvent and a value of the solubility parameter (δ3) of the oil-soluble resin is within a range of not more than 3.0 (J/cm³)^{1/2}, and is preferably within a range of not more than 2.0 (J/cm³)^{1/2}.

Thereby, affinity between the organic solvent and the oil-soluble resin becomes strong, and the oil-soluble resin is brought into a state where it is well dissolved in an organic solvent.

Like this, by satisfying the equation (5) and the equation (6), dissolution of the oil-soluble dye and the oil-soluble resin at manufacturing of the ink for marking becomes easy, and a problem does not occur that the oil-soluble dye is precipitated by vibration and a temperature change when the ink for marking is transported or stored.

Further, a problem does not occur that the oil-soluble dye and the oil-soluble resin contained in the ink for marking are precipitated to clog a supply tube and an ink jet nozzle, due to a pressure change occurring when the ink for marking is supplied to the ink jet nozzle or discharged from the ink jet nozzle. Therefore, it is possible to provide the ink for marking which has well stability of the ink.

Subsequently, in the equation (7), it is necessary that an absolute value of a difference between a value of the solubility parameter (δ2) of the oil-soluble dye and a value of the solubility parameter (δ3) of the oil-soluble resin is within a range of not more than 3.0 (J/cm³)^{1/2}, and is preferably within a range of not more than 2.0 (J/cm³)^{1/2}.

Thereby, affinity between the oil-soluble dye and the oil-soluble resin becomes strong, and a film from the oil-soluble resin is brought into a stably colored state by means of the oil-soluble dye, after formation thereof.

Further, in the equation (8), it is necessary that an absolute value of a difference between a value of the solubility parameter (δ3) of the oil soluble resin and a value of the solubility parameter (δ4) of the electrically insulating resin (corresponding to the resin for the article, as previously described) is within a range of not more than 5.0 (J/cm³)^{1/2}. It is preferably that the above solute value is in a range of not more than 4.0 (J/cm³)^{1/2}, and is further preferably within a range of not more than 3.0 (J/cm³)^{1/2}.

Thereby, affinity between the oil-soluble resin and the electrically insulating resin (corresponding to the resin for the article, as previously described) becomes strong and a film from the oil-soluble resin is brought into a state where it is stably marked on an outer surface of the electrically insulating resin (corresponding to the resin for the article, as previously described), after formation thereof.

Like this, by satisfying the equation (7) and the equation (8), it can be prevented to induce a problem of decoloration due to dissolution out of the oil-soluble dye from the film formed by the oil-soluble resin.

And, it can be also prevented to induce a problem that the film formed by the oil-soluble resin is peeled from a surface of the electrically insulating resin (corresponding to the resin for the article, as described above). Therefore, various fastnesses after marking are improved, and distinguishability after marking becomes well.

As previously described, the ink for marking which is used for marking an outer surface of a covering member of a covered electric wire becomes well in stability thereof and distinguishablity thereof after marking, by satisfying all of the equation (5), the equation (6), the equation (7) and the equation (8).

Next, a method will be explained for obtaining a solubility parameter of each of the organic solvent, the oil-soluble dye, the oil-soluble resin and the electrically insulating resin (corresponding to the resin for the article, as described above). In the present invention, there are many methods for obtaining the solubility parameter.

First, a value of the solubility parameter (δ1) of the organic solvent, which is fundamental, may be obtained by a reference value. For example, the value of the solubility parameter (δ1) may be obtained from the description of POLYMER HANDBOOK 4th Edition (J. Brandrup, E. H. Immergut, and E. A. Grulke, Editors).

Herein, in case two or more kinds of organic solvents are used by mixing thereof, a value of the solubility parameter (δ1) of the mixed organic solvent may be obtained by calculation based on solubility parameters of respective organic solvents to be mixed, and on a volume fraction of each of them. For example, the calculating method is given by “SP value Fundament/Application and Calculating Method”, Hideki Yamamoto, Johokiko Co., Ltd. (2005).

Next, a value of the solubility parameter (δ2) of the oil-soluble dye is hardly published in reference values. Therefore, the value of the solubility parameter (δ2) is measured.

In this measurement, a method is used for obtaining a solubility parameter of the oil-soluble dye as a solute from each solubility parameter of solvents in a group with the highest solubility for the oil-soluble dye. This solubility parameter of the solvent with the highest solubility is obtained by performing a dissolution experiment with usage of various solvents having the known solubility parameters.

With this method, δd (dispersion component), δp (polar component) and δh (hydrogen bonding component) which are respective components of solubility parameter (Hansen parameter) of respective solvents in a group with the highest solubility are plotted by separating into every component, and a central value is obtained for every component.

Using these central values respectively, a solubility parameter of the unknown substance may be obtained as a value of each component of a solubility parameter of a substance for which a solubility parameter is tried to be obtained. Details of this method are described, for example, in The Book and Paper Group ANNUAL Vol. 3 (1984) “Solubility Parameters: Theory and Application”.

A value of the solubility parameter (δ3) of the oil-soluble resin may not be obtained from reference values. This is the reason why commercially available products are used as the oil-soluble resin used in the present invention, as it is in many cases, and solubility parameters of almost of those commercially available resins are not published. And, commercially available products have copolymerization incorporations and molecular weights which are various depending on each company, and general values such as reference values can not be used.

Therefore, solubility parameters of these oil-soluble resins are obtained by measurement. In this case, there occurs often a scatter in values which is given by the method for obtaining solubility parameters from solubility obtained by the dissolution experiment, as described above.

In such a case, the solubility parameters are obtained by Turbidimetric Titration, as described below.

That is, a resin for which a solubility parameter is tried to be obtained is dissolved in a good solvent with the known solubility parameter. Then, a turbidimetric titration is performed using a poor solvent with a value of a solubility parameter greater than that of the good solvent. And another turbidimetric titration is performed using a poor solvent with a value of a solubility parameter smaller than that of the good solvent.

A value of a solubility parameter of the oil-soluble resin may be obtained by a calculation equation shown in the following reference. The calculation equation is given, for example, by K. W. SUH, D. H. CLARKE, JOURNAL OF POLYMER SCIENCE: PART A-1, Vol. 5, 1671-1681 (1967).

Next, a value of the solubility parameter (δ4) of the electrically insulating resin (corresponding to the resin for the article, as previously described) is measured by means of the aforementioned measuring method.

However, the aforementioned measuring method is difficult in some cases. That is, this is the case where an additive such as a plasticizer, a filler or the like is mixed in some cases when a covering member of a covered electric wire is formed, and a precise value may not be obtained by the aforementioned method.

In this case, a range has been grasped from reference values, and a representative value has been used. The value is described, for example, in the aforementioned POLYMER HANDBOOK 4th Edition (J. Brandrup, E. H. Immergut, and E. A. Grulke, Editors).

By the aforementioned method, a solubility parameter may be obtained for each of the organic solvent, the oil-soluble dye, the oil-soluble resin and the electrically insulating resin (corresponding to the resin for the article, as previously described).

By previously obtaining these solubility parameters in relation to individual components, each component of the ink for marking which is optimal thereto may be easily combined, in case the electrically insulating resin (corresponding to the resin for the article, as previously described) to be marked is determined.

Next, the present inventors have further found out that the object of the present invention may be attained better by the fact that a surface tension of the ink for marking is maintained at a value within a constant range, the ink for marking having the aforementioned relationship which is used, particularly, against a covering member of a covered electric wire using polyolefin resin.

That is, it is suitable that the ink for marking in accordance with the present invention has a surface tension within a range of 20 to 28 (mN/m).

It is required to make a contact angle smaller for easily wetting an outer surface of the covering member of the covered electric wire by means of the ink for marking. Thus, it is required that a value of a surface tension of the ink for marking is smaller than a value of a surface tension of the electrically insulating resin (corresponding to the resin for the article, as previously described).

Conversely, in case a value of a surface tension of the ink for marking is greater than a value of a surface tension of the electrically insulating resin (corresponding to a resin for an article), the contact angle is greater, the ink for marking becomes a liquid droplet on an outer surface of the covering member of the covered electric wire, and is not spread. As the result, clear marking may not be performed.

Herein, a surface tension of the polyolefin resin is generally given as a value within 29 to 31 (mN/m) according to the references.

In this case, in case the ink for marking has a surface tension within a range of 20 to 28 (mN/m), it may wet well an outer surface of the covering member of the covered electric wire adopting the polyolefin resin with which the conventional ink for marking may not perform marking sufficiently.

As the result, the ink for marking in accordance with the present invention can mark clearly an outer surface of the covering member of the covered electric wire adopting a polyolefin resin.

Herein, a surface tension of the ink for marking may be measured by various methods. In the present invention, the surface tension has been measured with a dynamic surface tension meter (principle: maximum foam pressure method). As a measuring device, Dyno Tester of SITA co. Ltd. is exemplified.

According to this embodiment, as previously described, can be provided an ink for marking which is used for marking an outer surface of a covering member of a covered electric wire and is excellent in stability and distingushability after marking.

In addition, an ink for marking which is excellent in stability and distingushability after marking under the aforementioned relationship can be provided against a covering member of a covered electric wire adopting a polyolefin resin with which a conventional ink for marking may not perform marking sufficiently.

Hereinafter, in this embodiment, following respective working examples and respective comparative examples have been prepared, and assessed. In addition, the present invention is not limited by these working examples at all.

### WORKING EXAMPLE 1

### Preparation of an Ink for Marking

1 (g) of an oil-soluble dye (C.I. Solvent Blue 70) and 5 (g) of an oil-soluble resin (Dianal BR-102, acryl resin manufactured by Mitsubishi Rayon Co., Ltd.) were sufficiently stirred and dissolved into 94(g) of an acetone, and thereafter filtered by a 1.0 (m) membrane filter to obtain a blue ink for marking (ink-1).

### Marking Test:

Using a piezo-ink-jet system (nozzle diameter; 0.1 (mm)), the ink-1 was discharged on an outer surface of each covering member of a polyvinyl chloride resin-covered electric wire (outer diameter; 1.3 (mm)), a polyethylene resin-covered electric wire (outer diameter; 1.3 (mm)) and a polypropylene resin-covered electric wire (outer diameter; 1.3 (mm)), being followed by drying at a room temperature.

### Solubility Parameters:

In the ink-1, a solubility parameter (1) of an organic solvent (acetone) was 20.3 according to the reference value. A solubility parameter (δ2) of the oil-soluble dye (C.I. Solvent Blue 70) was 20.5 according to a dissolution experiment.

A solubility parameter (δ3) of the oil-soluble resin (Dianal BR-102) was 19.0 according to turbidimetric titration. In addition, both of the reference value and an actual measured value were used as a solubility parameter (δ4) of each of the polyvinyl chloride resin (hereinafter, referred to as “PVC”), the polyethylene resin (hereinafter, referred to as “PE”) and the polypropylene resin (hereinafter, referred to as “PP”) corresponding to a resin for an article.

A solubility parameter (δ4) was 20.1 for PVC, 16.4 for PE or 19.2 for PP according to the reference value. On the other hand, the solubility parameter (δ4) was 20.0 for PVC, 17.6 for PE or 17.5 for PP, when a resin for an article of each covered electric wire actually used in a marking test was subjected to turbidimetric titration.

### WORKING EXAMPLE 2

### Preparation of an Ink for Marking

1 (g) of an oil-soluble dye (C.I. Solvent Blue 68) and 5 (g) of an oil-soluble resin (Dianal BR-113, acryl resin manufactured by Mitsubishi Rayon Co., Ltd.) were sufficiently stirred and dissolved in 94 (g) of an acetone, and thereafter filtered by a 1.0 μm membrane filter to obtain a blue ink for marking (ink-2).

### Marking Experiment:

The same test as that of the working example 1 was performed by using the ink-2.

### Solubility Parameters:

In the ink-2, a solubility parameter (1) of an organic solvent (acetone) was 20.3 according to the reference value. A solubility parameter (δ2) of the oil-soluble dye (C.I. Solvent Blue 68) was 20.7 according to a dissolution experiment.

A solubility parameter (δ3) of the oil-soluble resin (Dianal BR-113) was 21.2 according to turbidimetric titration. Furthermore, a solubility parameter (δ4) of the resin for an article was 20.1 for PVC, 16.4 for PE or 19.2 for PP according to the reference value. On the other hand, the solubility parameter (δ4) was 20.1 for PVC, 17.6 for PE or 17.5 for PP according to turbidimetric titration.

### WORKING EXAMPLE 3

### Preparation of an Ink for Marking

1 (g) of an oil-soluble dye (C.I. Solvent Yellow 56) and 5 (g) of an oil-soluble resin (polyvinyl acetate, extra pure reagent manufactured by Yoneyama Yakuhin Kogyo Co., Ltd.) were sufficiently stirred and dissolved in 94 (g) of an acetone, and thereafter filtered by a 1.0 μm membrane filter to obtain an yellow ink for marking (ink-3).

### Marking Test:

The same test as that of the working example 1 was performed by using the ink-3.

### Solubility Parameters:

In the ink-3, a solubility parameter (δ1) of the organic solvent (acetone) was 20.3 according to the reference value. A solubility parameter (2) of the oil-soluble dye (C.I. Solvent Yellow 56) was 20.5 according to a dissolution experiment.

A solubility parameter (δ3) of the oil-soluble resin (polyvinyl acetate) was 19.4 according to the reference value. Furthermore, a solubility parameter (δ4) of the resin for an article was 20.1 for PVC, 16.4 for PE or 19.2 for PP according to each reference value. On the other hand, the solubility parameter (δ4) was 20.0 for PVC, 17.6 for PE or 17.5 for PP according to turbidimetric titration.

### WORKING EXAMPLE 4

### Preparation of an Ink for Marking

1 (g) of an oil-soluble dye (C.I. Solvent Red 233) and 5 (g) of an oil-soluble resin (Dianal BR-102, acryl resin manufactured by Mitsubishi Rayon Co., Ltd.) were sufficiently stirred and dissolved in 94 (g) of a methyl ethyl ketone, and thereafter filtered by using a 1.0 μm membrane filter to obtain a red ink for marking (ink-4).

### Marking Test:

The ink-4 was discharged on an outer surface of each covering member as in working example 1, and was dried with the hot air at 40° C.

### Solubility Parameters:

In the ink-4, a solubility parameter (δ1) of the organic solvent (methyl ethyl ketone) was 19.0 according to the reference value. A solubility parameter (δ2) of the oil-soluble dye (C.I. Solvent Red 233) was 19.0 according to a dissolution experiment.

A solubility parameter (δ3) of the oil-soluble resin (Dianal BR-102) was 19.0 according to turbidimetric titration. Furthermore, a solubility parameter (δ4) of the resin for an article were 20.1 for PVC, 16.4 for PE or 19.2 for PP according to the reference value. On the other hand, the solubility parameter (δ3) was 20.0 for PVC, 17.6 for PE or 17.5 for PP according to turbidimetric titration.

### WORKING EXAMPLE 5

### Preparation of an Ink for Marking

1 (g) of an oil-soluble dye (C.I. Solvent Blue 70) and 5 (g) of an oil-soluble resin (Dianal BR-113, acryl resin manufactured by Mitsubishi Rayon Co., Ltd.) were sufficiently stirred and dissolved in 94(g) of an acetone, and thereafter filtered by using a 1.0 μm membrane filter to obtain a blue ink for marking (ink-5).

### Marking Test:

The same test as that of working example 4 was performed by using the ink-5.

### Solubility Parameters:

In the ink-5, a solubility parameter (1) of the organic solvent (acetone) was 20.3 according to the reference value.

A solubility parameter (δ2) of the oil-soluble dye (C.I. Solvent Blue 70) was 20.5 according to a dissolution experiment.

A solubility parameter (δ3) of the oil-soluble resin (Dianal BR-113) was 21.2 according to turbidimetric titration. Furthermore, a solubility parameter (δ4) of the resin for an article was 20.1 for PVC, 16.4 for PE or 19.2 for PP according to the reference value. On the other hand, the solubility parameter (δ4) was 20.0 for PVC, 17.6 for PE or 17.5 for PP according to turbidimetric titration.

### WORKING EXAMPLE 6

### Preparation of an Ink for Marking

1 (g) of an oil-soluble dye (C.I. Solvent Violet 33) and 5 (g) of an oil-soluble resin (Dianal BR-102, acryl resin manufactured by Mitsubishi Rayon Co., Ltd.) were sufficiently stirred and dissolved in 94 (g) of a methyl ethyl ketone, and thereafter filtered by using a 1.0 μm membrane filter to obtain a violet ink for marking (ink-6).

### Marking Test:

The same test as that of working example 4 was performed by using the Ink-6.

### Solubility Parameters:

In the ink-6, a solubility parameter (δ1) of the organic solvent (methyl ethyl ketone) was 19.0 according to the reference value. A solubility parameter (δ2) of the oil-soluble dye (C.I. Solvent Violet 33) was 20.1 according to a dissolution experiment.

A solubility parameter (δ3) of the oil-soluble resin (Dianal BR-102) was 19.0 according to turbidimetric titration. Furthermore, a solubility parameter (δ4) of the resin for an article was 20.1 for PVC, 16.4 for PE or 19.2 for PP according to the reference value. On the other hand, the solubility parameter (δ3) was 20.0 for PVC, 17.6 for PE or 17.5 for PP according to turbidimetric titration.

### WORKING EXAMPLE 7

### Preparation of an Ink for Marking

1 (g) of an oil-soluble dye (C.I. Solvent Blue 70) and 5 (g) of an oil-soluble resin (Dianal BR-102, acryl resin manufactured by Mitsubishi Rayon Co., Ltd.) were sufficiently stirred and dissolved in 94 (g) of a methyl ethyl ketone, and thereafter filtered by using a 1.0 m membrane filter to obtain a blue ink for marking (ink-7).

### Marking Test:

The same test as that of working example 4 was performed by using the ink-7.

### Solubility Parameters:

In the ink-7, a solubility parameter (δ1) of the organic solvent (methyl ethyl ketone) was 19.0 according to the reference value. A solubility parameter (δ2) of the oil-soluble dye (C.I. Solvent Blue 70) was 20.5 according to a dissolution experiment.

A solubility parameter (δ3) of the oil-soluble resin (Dianal BR-102) was 19.0 according to turbidimetric titration. Furthermore, a solubility parameter (δ4) of the resin for an article was 20.1 for PVC, 16.4 for PE or 19.2 for PP according to the reference value. On the other hand, the solubility parameter (δ3) was 20.0 for PVC, 17.6 for PE or 17.5 for PP according to turbidimetric titration.

### COMPARATIVE EXAMPLE 1

### Preparation of an Ink for Marking

1 (g) of an oil-soluble dye (C.I. Solvent Yellow 88) and 5 (g) of an oil-soluble resin (Dianal BR-106, acryl resin manufactured by Mitsubishi Rayon Co., Ltd.) were sufficiently stirred in 94 (g) of a cyclohexane to obtain a yellow ink for marking (ink-8).

However, the ink-8 was deficient in dissolution stability, and could not be filtered by using a 1.0 μm membrane filter.

### Marking Test:

A polyvinyl chloride resin-covered electric wire (outer diameter; 1.3 mm) was tried to be tested as in the working example 1 by using the ink-8. However, the ink-8 was deficient in dissolution stability as described above. Therefore, a marking test was not performed.

### Solubility Parameters:

In the ink-8, a solubility parameter (1) of an organic solvent (cyclohexane) was 16.8 according to the reference value.

A solubility parameter (δ2) of the oil-soluble dye (C.I. Solvent Yellow 88) was 23.1 according to a dissolution experiment.

A solubility parameter (δ3) of the oil-soluble resin (Dianal BR-106) was 20.9 according to turbidimetric titration. Furthermore, a solubility parameter (δ4) of the resin for an article (PVC) was 20.1 according to the reference value. On the other hand, the solubility parameter (δ3) was 20.0 according to turbidimetric titration.

### COMPARATIVE EXAMPLE 2

### Preparation of an Ink for Marking

1 (g) of an oil-soluble dye (C.I. Solvent Red 233) and 5 (g) of an oil-soluble resin (Dianal BR-87, acryl resin manufactured by Mitsubishi Rayon Co., Ltd.) were sufficiently stirred in 94 (g) of a cyclohexane to obtain a red ink for marking (ink-9).

However, the ink-9 was deficient in dissolution stability, and could not be filtered by using a 1.0 μm membrane filter.

### Marking Test:

A polyethylene resin-covered electric wire (outer diameter; 1.3 mm) was tried to be tested as in the working example 1 by using the ink-9. However, the ink-9 was deficient in dissolution stability as described above. Therefore, a marking test was not performed.

### Solubility Parameters:

In the ink-9, a solubility parameter (1) of an organic solvent (cyclohexane) was 16.8 according to the reference value.

A solubility parameter (δ2) of the oil-soluble dye (C.I. Solvent Red 233) was 19.0 according to a dissolution experiment.

A solubility parameter (δ3) of the oil-soluble resin (Dianal BR-87) was 21.0 according to turbidimetric titration. Furthermore, a solubility parameter (δ4) of the resin for an article (PE) was 16.4 according to the reference value. On the other hand, the solubility parameter (δ3) was 17.6 according to turbidimetric titration.

### COMPARATIVE EXAMPLE 3

### Preparation of a Marking Ink

1 (g) of an oil-soluble dye (C.I. Solvent Yellow 88) and 5 g of an oil-soluble resin (Dianal BR-102, acryl resin manufactured by Mitsubishi Rayon Co., Ltd.) were sufficiently stirred and dissolved in 94 (g) of a cyclohexanone, and thereafter filtered by using a 1.0 μm membrane filter to obtain an yellow ink for marking (ink-10).

### Marking Test:

A polypropylene resin-covered electric wire (outer diameter; 1.3 mm) was subjected to the same test as that of the working example 1 by using the ink-10.

### Solubility Parameters:

In the ink-10, a solubility parameter (δ1) of an organic solvent (cyclohexanone) was 21.3 according to the reference value. A solubility parameter (δ2) of the oil-soluble dye (C.I. Solvent Yellow 88) was 23.1 according to a dissolution experiment.

A solubility parameter (δ3) of the oil-soluble resin (Dianal BR-102) was 19.0 according to turbidimetric titration. Furthermore, a solubility parameter (δ4) of the resin for an article (PP) was 19.2 according to the reference value. On the other hand, the solubility parameter (δ3) was 17.5 according to turbidimetric titration.

Herein, Table 1 shows absolute values of a difference between solubility parameters of respective components of the inks for marking (the ink-1 to the ink-10) and of respective resins for an article (PVC, PE and PP) of the respective working and comparative examples. Additionally, the Table 1 shows values of a surface tension of each ink for marking.

TABLE 1

| | | absolute value of difference | | | | | |
|---|---|---|---|---|---|---|---|
| | | in solubility parameters | | | | | |
| | resin | | | | \|δ3-δ4\| | | |
| | for | | | | δ4 from | δ4 from | surface |
| | arti- | \|δ1- | \|δ1- | \|δ2- | reference | actually | tension |
| | cle | δ2\| | δ3\| | δ3\| | value | measured | (mN/m) |
| working | PVC | 0.2 | 1.3 | 1.5 | 1.1 | 1.0 | 23.0 |
| example 1 | PE | 0.2 | 1.3 | 1.5 | 2.6 | 1.3 | 23.0 |
| | PP | 0.2 | 1.3 | 1.5 | 0.2 | 1.5 | 23.0 |
| working | PVC | 0.4 | 0.9 | 0.5 | 1.1 | 1.2 | 21.4 |
| example 2 | PE | 0.4 | 0.9 | 0.5 | 4.8 | 3.6 | 21.4 |
| | PP | 0.4 | 0.9 | 0.5 | 2.0 | 3.7 | 21.4 |
| working | PVC | 0.2 | 0.9 | 1.1 | 0.7 | 0.6 | 21.9 |
| example 3 | PE | 0.2 | 0.9 | 1.1 | 3.0 | 1.8 | 21.9 |
| | PP | 0.2 | 0.9 | 1.1 | 0.2 | 1.9 | 21.9 |
| working | PVC | 0 | 0 | 0 | 1.1 | 1.0 | 23.9 |
| example 4 | PE | 0 | 0 | 0 | 2.6 | 1.4 | 23.9 |
| | PP | 0 | 0 | 0 | 0.2 | 1.5 | 23.9 |
| working | PVC | 0.2 | 0.9 | 0.7 | 1.1 | 1.2 | 21.4 |
| example 5 | PE | 0.2 | 0.9 | 0.7 | 4.8 | 3.6 | 21.4 |
| | PP | 0.2 | 0.9 | 0.7 | 2.0 | 3.7 | 21.4 |
| working | PVC | 1.1 | 0 | 1.1 | 1.1 | 1.0 | 23.9 |
| example 6 | PE | 1.1 | 0 | 1.1 | 2.6 | 1.4 | 23.9 |
| | PP | 1.1 | 0 | 1.1 | 0.2 | 1.5 | 23.9 |
| working | PVC | 1.5 | 0 | 1.5 | 1.1 | 1.0 | 23.9 |
| example 7 | PE | 1.5 | 0 | 1.5 | 2.6 | 1.4 | 23.9 |
| | PP | 1.5 | 0 | 1.5 | 0.2 | 1.5 | 23.9 |
| compar- | PVC | 6.3 | 4.1 | 2.2 | 0.8 | 0.9 | 22.0 |
| ative | | | | | | | |
| example 1 | | | | | | | |
| compar- | PE | 2.2 | 4.2 | 2.0 | 4.6 | 3.4 | 22.0 |
| ative | | | | | | | |
| example 2 | | | | | | | |
| compar- | PP | 1.8 | 2.3 | 4.2 | 0.2 | 1.5 | 30.0 |
| ative | | | | | | | |
| example 3 | | | | | | | |

According to this Table 1, it is understood that all of the inks for marking of the working examples 1 to 7 (the ink-1 to the ink-7) satisfy conditions of the present invention.

To the contrary, inks for marking of the comparative examples 1 to 3 (the ink-8 to the ink-10) do not satisfy all of the conditions of the present invention. Particularly, with the ink-8, each value of |δ1−δ2| and |δ1−δ3| is greater than 3.0 (J/cm³)^{1/2}. Similarly, with the ink-9, a value of |δ1−δ3| is greater than 3.0 (J/cm³)^{1/2}. On the other hand, with the ink-10, a value of 162-631 is greater than 3.0 (J/cm³)^{1/2}.

In addition, there occurs often a slight difference between a value of |δ3−δ4| where in the reference value is used as a value of 64 and a value of |δ3−δ4| wherein an actually measured value is used as a value of 64. However, under the above-mentioned slight difference, the conditions of the present invention are satisfied.

Next, inks for marking of the working examples were assessed for their performance. With this assessment, stability of an ink for marking was assessed based on the state of the ink, and distinguishability after marking was assessed based on the state of a covered electric wire after marking.

For these assessments, filter permeability and temperature stability were adopted as assessment items to stability of the ink. And, clearness and adhesiveness of marking were adopted as assessment items to distinguishability after marking. These four assessment items were respectively assessed at three stages of “G” indicative of “GOOD”, “F” indicative of “FAIR” and “P” indicative of “POOR”. And, having four “G” or three “G” and one “F” among four assessment items, the ink for marking was passed. That is to say, having two or more “F” or one or more “P” among four assessment items, the ink for marking was failure.

The filter permeability was assessed by a permeation resistance and an amount of the residue remaining on the filter when permeated through a 0.45 μm membrane filter (OMNIPORE MEMBRANEFILTERS 0.45 μm JM manufactured by Millipore Corporation). Assessment was performed by three stages of “G” indicative of “GOOD” and corresponding to no problem, “F” indicative of “FAIR” and corresponding to presence of a permeation resistance but no residue, and “P” indicative of “POOR” and corresponding to a great permeation resistance, much residue, and not filterable.

For assessing the above-mentioned temperature stability, the inks for marking were stood for 7 days at 0° C. and for 2 months at 50° C., respectively. Thereafter, the above-mentioned temperature stability was assessed by presence or absence of precipitates and a change in a viscosity of the precipitates. Assessment was performed by three stages of “G” indicative of “GOOD” and corresponding to no change, “F” indicative of “FAIR” and corresponding to observation of slight change, but usable, and “P” indicative of “POOR” and corresponding to presence of change and not usable.

The clearness of marking was assessed visually regarding a covered electric wire after marking with ink jet system.

Assessment was performed by three stages of “G” indicative of “GOOD” and corresponding to good distinguishment of a mark, “F” indicative of “FAIR” corresponding to difficulty to distinguish a mark, and “P” indicative of “POOR” and corresponding to impossibility to distinguish a mark.

The adhesiveness was assessed by a cellophane tape method. Assessment by the cellophane tape method was performed by sticking a cellophane tape to a marking surface of a covered electric wire, and thereafter peeling the stuck cellophane tape.

The assessment was performed by three stages of “G” indicative of “GOOD” and corresponding to no transference onto a cellophane tape, “F” indicative of “FAIR” and corresponding to the presence of transference, but possibility to distinguish a mark, and “P” indicative of “POOR” and corresponding to peeling of a mark, and impossibility to distinguish a mark.

Table 2 shows results of the above-mentioned each assessment on each resin for an article (PVC, PE and PP) in relation to the inks (the ink-1 to the ink-10) for marking of the respective working and comparative examples.

TABLE 2

| | | | | distinguishability | |
|---|---|---|---|---|---|
| | | stability of ink | | after marking | |
| | resin for | filter | temperature | clear- | adhesive- |
| | article | permeability | stability | ness | ness |
| working | PVC | F | G | G | G |
| example 1 | PE | F | G | G | G |
| | PP | F | G | G | G |
| working | PVC | G | G | G | G |
| example 2 | PE | G | G | G | F |
| | PP | G | G | G | G |
| working | PVC | G | G | G | G |
| example 3 | PE | G | G | G | G |
| | PP | G | G | G | G |
| working | PVC | F | G | G | G |
| example 4 | PE | F | G | G | G |
| | PP | F | G | G | G |
| working | PVC | G | G | G | G |
| example 5 | PE | G | G | G | F |
| | PP | G | G | G | G |
| working | PVC | F | G | G | G |
| example 6 | PE | F | G | G | G |
| | PP | F | G | G | G |
| working | PVC | F | G | G | G |
| example 7 | PE | F | G | G | G |
| | PP | F | G | G | G |
| comparative | PVC | P | — | — | — |
| example 1 | | | | | |
| comparative | PE | P | — | — | — |
| example 2 | | | | | |
| comparative | PP | G | G | G | P |
| example 3 | | | | | |

According to this Table 2, it is understood that all of inks for marking of the working examples 1 to 7 (the ink-1 to the ink-7) are excellent in filter permeability and temperature stability as stability of an ink, and clearness and adhesiveness of marking as distinguishability after marking.

To the contrary, inks for marking of the comparative examples 1 to 3 (the ink-8 to the ink-10) have “P” in any of assessments, and are not passed.

Herein, the ink-8 and the ink-9 could not be filtered by using a 1.0 μm membrane filter at preparation of the ink for marking. Thus, in the Table 2, filter permeability was assessed to be “P”, and other assessment was not performed.

On the other hand, the ink-10 was well in filter permeability and temperature stability as stability of an ink. However, the ink-10 was bad in adhesiveness of marking as distinguishability after marking, and induced peeling.

Herein, in the Table 1, the ink-10 satisfies the conditions of the present invention in a value of |δ3−δ4| which is thought to be involved with adhesiveness.

However, a value of |δ2−δ3| which is thought to be involved with compatibility between the oil-soluble dye and the oil-soluble resin is greater than 3.0 (J/cm³)^{1/2}. Therefore, it is thought that an oil-soluble resin containing an oil-soluble dye deteriorates adhesiveness with PP which is a resin for an article.

In addition, upon embodying the present invention, there are following various modifications in addition to the aforementioned embodiment.

(1) The present invention may be used for marking of articles such as a connector, a tube, a tape, a cover, a clip and the like in addition to a covered electric wire adopted as a wire harness constituting member.
(2) The present invention may be adopted in a wire harness for buildings or houses in addition to a wire harness for an automobile.
(3) The ink for marking in accordance with the present invention may be used also in various impartation methods such as coating with a roller, and dipping impartation by a dipping manner.

1. An ink for marking which marks an outer surface of an article having at least the outer surface formed of a resin, wherein said ink for marking comprises an organic solvent, an oil-soluble dye and an oil-soluble resin, and wherein the following respective equations are satisfied:

|δ1−δ2|≦3.0 (J/cm³)^{1/2}

|δ1−δ3|≦3.0 (J/cm³)^{1/2}

|δ2−δ3|≦3.0 (J/cm³)^{1/2}

|δ3−δ4|≦3.0 (J/cm³)^{1/2}
when a solubility parameter of the organic solvent is denoted by δ1, a solubility parameter of the oil-soluble dye is denoted by δ2, a solubility parameter of the oil-soluble resin is denoted by δ3 and a solubility parameter of the resin for an article is denoted by δ4.

2. An ink for marking as claimed in claim 1, wherein said ink for marking has a value of a surface tension within a range of 20 to 28 (mN/m).

3. An ink for marking as claimed in claim 1, wherein said organic solvent contains acetone or methyl ethyl ketone at 80% or more of a volume fraction thereof.

4. An ink for marking as claimed in claim 2, wherein said organic solvent contains acetone or methyl ethyl ketone at 80% or more of a volume fraction thereof.
